(19) United States
(12) Patent Application Publication
(10) Pub. No.: US 2006/0192183 A1
(43) Pub. Date: Aug. 31, 2006

(54) Metal ink, method of preparing the metal ink, substrate for display, and method of manufacturing the substrate

(76) Inventors: Andreas Klyszcz, Berlin (DE); Marcus Schaedig, Konigs Wusterhausen (DE); Werner Humbs, Berlin (DE)

Correspondence Address: Robert E. Bushnell, Suite 300, 1522 K Street, N.W., Washington, DC, 20005, US

(21) Appl. No.: 11/361,362

(22) Filed: Feb. 24, 2006

(30) Foreign Application Priority Data
Feb. 28, 2005 (EP) 05 101 515.4
Jun. 16, 2005 (KR) 10-2005-0051991

(51) Int. Cl. H01B 1/12

(52) U.S. Cl. 252/500

(57) ABSTRACT

A metal ink for ink-jet printing conductive lines, a method of preparing the metal ink, a substrate for a display having a plurality of ink-jet printed conductive lines, and a method of manufacturing the substrate are provided. The metal ink includes dispersed metal nano powders and a solvent, wherein the metal ink includes antiabrasion-promoting nano particles and/or a flexibility-promoting polymer. The dispersed metal nano powders include at least one of silver, gold, platinum, palladium nickel, and/or copper. The metal ink for ink-jet printing conductive lines improves the adhesion, abrasive resistance and flexibility of ink-jet printed conductive lines, such as, ink-jet printed address and bus electrodes, to a ground substrate.

### CROSS-REFERENCE TO RELATED PATENT APPLICATION AND CLAIM OF PRIOTRITY

This application claims the benefit of European Patent Application No. 05 101 515.4, filed on Feb. 28, 2005, in the European Intellectual Property Office, and Korean Patent Application No. 10-2005-0051991, filed on Jun. 16, 2005, in the Korean Intellectual Property Office, the disclosure of which is incorporated herein in its entirety by reference.

### BACKGROUND OF THE INVENTION

1. Field of the Invention

The present invention relates to metal ink for ink-jet printing conductive lines, a method of preparing the metal ink, a substrate for a display having a plurality of ink-jet printed conductive lines, and a method of manufacturing the substrate. More particularly, the present invention relates to metal ink and a substrate for a plasma display panel (PDP) having a plurality of ink-jet printed conductive lines for address and bus electrodes.

2. Description of the Related Art

Ink-jet printed bus and address electrodes in PDPs are printed with nano particle ink. Metal nano particle ink is composed of individually dispersed metal nano particles, and a dispersant (European Patent Publication No. 1349135A1 to ULVAC Inc., US Patent Publication No. 20040043691A1 to Abe et al).

US Patent Publication No. 20040038616A1 to Toyota et al. describes a method of manufacturing a substrate for a flat panel display, the method including: forming a plurality of grooves on the bottom of a float glass substrate by a subtractive process to form barrier ribs including protrusions between the individual grooves, and then forming electrodes on the bottoms of the grooves by an ink-jet process or a dispersing process. An alternative process of forming narrow metal lines on glass or an indium tin oxide (ITO) surface with nano particle ink is to treat the substrate moderately to have a contact angle of 60° for the nano particle ink (US Patent Publication No. 20030083203A1 to Hashimoto et al.). In conventional surface treatment methods, like fluorination with CF₄, C₂F₆, C₃F₈ or fluoroalkyl-functionalized silanes, the contact angles of 20° to 60° can be achieved, but the drawback is a loss in adhesion of the printed and cured metal lines.

U.S. Pat. No. 6,387,519 discloses multi-component composite coatings of high scratch-resistant color-plus-clear coatings capable of retaining scratch-resistance after weathering.

U.S. Pat. No. 6,118,426 discloses a process of producing an electronically addressable display, which includes multiple printing operations similar to multi-color processes in conventional screen-printing operations. In the some processes, electrically non-active ink is printed on receiving regions of a substrate, and in other processes, electrically active ink is printed on other regions of the substrate.

US Patent Publication No. 20030168639A1 discloses metallic nano particle cluster ink and a method of forming a conductive metal pattern using the cluster ink. The metallic nano particle cluster ink includes colloidal metallic nano particles and bifunctional compounds. The conductive metal pattern is formed by forming a metallic nano particle pattern on a substrate with a polydimethylsiloxane-polymer (PDMS-polymer) mold as a stamp and by heat-treating the substrate. Micrometer-sized conductive metal patterns can be easily formed on various substrates in a simple and inexpensive manner without the use of costly systems, thereby being very useful in various industrial fields.

European Patent Publication No. 1383597 discloses a metal nano particle colloid solution, metal-polymer nano-composites, and methods of preparing the same. The metal nano particle colloid solution and the metal-polymer nano-composites can be prepared with various polymeric stabilizers and have uniform particle diameter and shape. The metal nano particle colloid solution and the metal-polymer nano-composites have wide applications, such as an antibacterial agent, a sterilizer, a conductive adhesive, conductive ink and an electromagnetic wave shield for an image display.

Japanese Patent Publication No. 2004-207659 discloses a water-shedding printed region formed by printing in water-shedding ink on the surface of a non-circuit pattern region of a substrate. When a water-based colloidal solution, wherein conductive nano metallic powders of an average grain diameter of 0.1 to 50 nm are dispersed, is applied onto the surface of the substrate, the colloidal solution is attached to only the unprinted region of the substrate, which becomes a circuit pattern region. Then, the substrate is heated, the conductive nano metallic powders are mutually fused by evaporating liquid alone in the colloidal solution, and a conductive metallic layer consisting of nano metallic powders is formed in the unprinted region. Thereafter, a circuit is manufactured.

However, in all the above-mentioned techniques, there is no consideration for sufficient abrasion resistance and adhesion of the ink, and flexibility of the ink printed substrate.

### SUMMARY OF THE INVENTION

The present invention relates to improving the adhesion of ink-jet printed conductive lines, for example, ink-jet printed address and bus electrodes to a ground substrate.

The present invention also relates to improving the abrasion resistance and the flexibility of ink-jet printed conductive lines for obtaining flexible ground substrates and increasing the life-time of the ground substrates.

According to an aspect of the present invention, there is provided a metal ink for ink-jet printing conductive lines that improves the abrasion resistance and flexibility of ink-jet printed conductive lines. The metal ink may include dispersed metal nano powders in a solvent, and at least one of antiabrasion-promoting nano particles and a flexibility-promoting polymer. The dispersed metal nano powders may include silver, gold, platinum, palladium, nickel and copper.

The antiabrasion-promoting nano particles improve the abrasion resistance of the ink-jet printed conductive lines and the flexibility-promoting polymer improves the flexibility of the ink-jet printed conductive lines. The antiabrasion-promoting nano particles may be at least one of colloidal silica nano particles, fumed silica nano particles, sol-gel nano particles, and carbon nano particles. The flexibility-promoting polymer may be a silicone polymer and/or a functionalized silicone polymer.

The silicone polymer may include at least one polysiloxane of Formula (I):
R¹ₙR²ₘSiO_{(4-n-m)/2} (I)
wherein each R¹, which may be identical or different, represents H, OH, a monovalent hydrocarbon group, or a monovalent siloxane group; each R², which may be identical or different, represents a group including at least one reactive functional group, where 0<n<4, 0<m<4 and 2≦(m+n)<4.

The reactive functional group may be selected from a hydroxyl group, a carboxyl group, an isocyanate group, a blocked polyisocyanate group, a primary amine group, a secondary amine group, an amide group, a carbamate group, a urea group, a urethane group, a vinyl group, an unsaturated ester group, a maleimide group, a fumarate group, an anhydride group, a hydroxy alkylamide group, and an epoxy group.

The silicone polymer may include at least one polysiloxane of Formula (II) or (III):
R₃Si—O—(SiR₂O—)ₙ—(SiRR^{a}O)ₘ—SiR₃ (II)
R^{a}R₂Si—O—(SiR₂O—)ₙ—(SiRR^{a}O)ₘ—SiR₂R^{a} (III)
wherein m is a value of at least 1; m′ ranges from 0 to 75; n ranges from 0 to 75; n′ ranges from 0 to 75; and each R, which may be identical or different, is selected from H, OH, a monovalent hydrocarbon group, a monovalent siloxane group and a mixture thereof; and R^{a} has Formula (IV):
—R³—X (IV)
wherein —R³ is selected from an alkylene group, an oxyalkylene group, an alkylene aryl group, an alkenylene group, an oxyalkenylene group, and an alkenylene aryl group; and X represents a group which includes at least one reactive functional group selected from a hydroxyl group, a carboxyl group, an isocyanate group, a blocked polyisocyanate group, a primary amine group, a secondary amine group, an amide group, a carbamate group, a urea group, a urethane group, a vinyl group, an unsaturated ester group, a maleimide group, a fumarate group, an anhydride group, a hydroxy alkylamide group, and an epoxy group.

Alternatively or in addition, the silicone polymer may include at least one polysiloxane which is the reaction product of at least one of the following reactants:
(i) at least one polysiloxane of Formula (V):
   R₃Si—O—(SiR₂O—)ₙ—SiR₃ (V)
   wherein R, which may be identical or different, represents a group selected from H, OH, a monovalent hydrocarbon group, a siloxane group and a mixture thereof, and at least one of the groups represented by R is H, and n′ ranges from 0 to 100, wherein the percentage of Si—H content in the least one polysiloxane ranges from 2 to 50; and
(ii) at least one molecule which includes at least one primary hydroxyl group and at least one unsaturated bond which can participate in a hydrolyzation reaction.

The metal nano powders in the ink and the antiabrasion-promoting nano particles/flexibility-promoting polymers may be crosslinked. The crosslinking is executed during the sintering of the ink which may be performed after the ink-jet printing of the ink, for example, to form the conductive lines on a substrate.

According to another aspect of the present invention, there is provided a method of preparing a metal ink with improved abrasion resistance, the metal ink includes mixing antiabrasion-promoting nano particles and/or a flexibility-promoting polymer with common metal ink. At least one of colloidal silica nano particles, fumed silica nano particles, sol-gel nano particles, and carbon nano particles may be used as the anti-abrasion-promoting nano particles. A silicone polymer and/or a functionalized silicone polymer may be used as the flexibility-promoting polymer.

The mixing process may be performed by sonication. A surface modification of silica particles may be performed by condensation reactions with silanes having at least one metal adhesion functional group, wherein the metal adhesion functional group has at least one N-, O-, S-, and/or P-atom. The metal adhesion functional group may be selected from amine, diamine, triamine, tetraamine, polyamine, pyridine, imidazole, carboxylic acid, sulfonic acid, phosphate, phosphonate, and phenol.

The sol-gel nano particles may be synthesized through the co-condensation reaction of organo(alkoxy)-silanes with at least one organic functional group, wherein at least N-, O-, S-, and/or P-atom is present, or transition metal alkoxides or copolymerization reactions of transition metal alkoxides with each other or with organic molecules are present.

According to still another aspect of the present invention, there is provided a substrate for a display including a ground substrate having a plurality of ink-jet printed conductive lines with improved adhesion and/or improved abrasion resistance and flexibility, the substrate including a metal adhesion promoting layer which is disposed between the ground substrate and the conductive lines, and at least one of antiabrasion-promoting nano particles and a flexibility-promoting polymer which are attached to the ground substrate and the conductive lines. The antiabrasion-promoting nano particles are preferably colloidal silica nano particles, fumed silica nano particles, sol-gel nano particles, and/or carbon nano particles. The flexibility-promoting polymer is preferably a silicone polymer and/or a functionalized silicone polymer.

The metal adhesion promoting layer may include crosslinked molecules of Formula (VI) or crosslinked molecules of Formula (VII) or crosslinked molecules of Formula (IX):
YRₙ (VI)
wherein Y is a N-, S-, or P-atom, n=2 or 3, and each R is independently a H-atom or an alkyl group;
ZR′ₘ (VII)
wherein Z is a N-, S-, or P-atom, m=2 or 3, and each R′ is independently a H-atom or a silane group of Formula (VIII):
SiR″₃ (VIII)
wherein R″ is an alkyl group, which may be identical or different; or
RSiX₄ (IX)
wherein R of Formula (IX) is a H-atom, an OH-group , a Cl-atom, or an alkoxy group, and each X is independently a H-atom, an OH-group, a Cl-atom, an alkoxy group, an alkyl group, or an organic group, wherein the organic group includes at least one metal binding group.

The organic group may include at least one of amine, diamine, triamine, tetraamine, polyamine, amide, polyamid, hydrazine, pyridine, imidazole, thiophene, carboxylic acid, carboxylic acid halogenide, sulfide, disulfide, trisulfide, tetrasulfide, polysulfide, sulfonic acid, sulfonic acid halogenide, phosphate, phosphonate, epoxide, phenol, and polyether.

According to yet another aspect of the present invention, there is provided a method of manufacturing a substrate for a display including a plurality of ink-jet printed conductive lines, the method including: forming a metal adhesion layer on a ground substrate; and applying a metal ink to the metal adhesion layer by ink-jet printing to form a plurality of conductive lines, wherein the metal ink comprises at least one of antiabrasion-promoting nano particles and a flexibility-promoting polymer which are attached to the ground substrate and the conductive lines. The antiabrasion-promoting nano particles are preferably colloidal silica nano particles, fumed silica nano particles, sol-gel nano particles, and carbon nano particles. The flexibility-promoting polymer is preferably a silicone polymer and/or a functionalized silicone polymer.

The metal adhesion promoting layer may be formed by a plasma treatment using NH₃, H₃S, and/or PH₃, a plasma treatment using a substance of Formula (VI), or a plasma polymerization with a silane of Formula (VII). Preferably, the substance of Formula (IX) is used in the forming the metal adhesion promoting layer. The metal adhesion promoting layer is formed by a wet chemical process. In this case, the metal adhesion promoting layer is formed by dipping the ground substrate into the solution of the substance of Formula (VI).

### BRIEF DESCRIPTION OF THE DRAWINGS

A more complete appreciation of the present invention, and many of the above and other features and advantages of the present invention, will be readily apparent as the same becomes better understood by reference to the following detailed description when considered in conjunction with the accompanying drawings in which like reference symbols indicate the same or similar components, wherein:

FIG. 1 is a sectional view of a substrate according to an embodiment of the present invention;

FIG. 2 illustrates the synthesis of particles and crosslinking, in particular, 2a to 2c illustrate the synthesis of amino-functionalized silica particles and their crosslinking with silver nano particles, and 2d to 2f illustrate the synthesis of epoxy-functionalized silica particles and their crosslinking to silver nano particles;

FIG. 3A illustrates the synthesis of epoxy-functionalized polysiloxane;

FIG. 3B illustrates the crosslinking of epoxy-functionalized polysiloxane to amino-functionalized silica particles; and

FIG. 3C illustrates the crosslinking of epoxy-functionalized polysiloxane to an adhesion promoting layer.

### DETAILED DESCRIPTION OF THE INVENTION

Hereinafter, the present invention will now be exemplarily described with reference to the attached drawings.

To improve the abrasion resistance and flexibility of ink-jet printed conductive lines, metal ink may include dispersed metal nano powders in a solvent, and at least one of antiabrasion-promoting nano particles and a flexibility-promoting polymer.

The dispersed metal nano powders may include silver, gold, platinum, palladium, nickel and copper.

The antiabrasion-promoting nano particles improve the abrasion resistance of the ink-jet printed conductive lines, and the flexibility-promoting polymer improves the flexibility of the ink-jet printed conductive lines.

The antiabrasion-promoting nano particles may be at least one of colloidal silica nano particles, fumed silica nano particles, sol-gel nano particles, and carbon nano particles.

The flexibility-promoting polymer may be a silicone polymer and/or a functionalized silicone polymer.

The silicone polymer may include at least one polysiloxane.

The polysiloxane may be represented by Formula (I):
R¹ₙR²ₘSiO_{(4-n-m)/2} (I)
wherein each R¹, which may be identical or different, represents H, OH, a monovalent hydrocarbon group, or a monovalent siloxane group; each R², which may be identical or different, represents a group including at least one reactive functional group, where 0<n<4, 0<m<4 and 2≦(m+n)<4.

The reactive functional group of each R² may be selected from a hydroxyl group, a carboxyl group, an isocyanate group, a blocked polyisocyanate group, a primary amine group, a secondary amine group, an amide group, a carbamate group, a urea group, a urethane group, a vinyl group, an unsaturated ester group, a maleimide group, a fumarate group, an anhydride group, a hydroxy alkylamide group, and an epoxy group.

The polysiloxane may be represented by Formula (II) or (III):
R₃Si—O—(SiR₂O—)ₙ—(SiRR^{a}O)ₘ—SiR₃ (II)
R^{a}R₂Si—O—(SiR₂O—)ₙ—(SiRR^{a}O)ₘ—SiR₂R^{a} (III)
wherein m is a value of at least 1; m′ ranges from 0 to 75; n ranges from 0 to 75; n′ ranges from 0 to 75; and each R, which may be identical or different, is selected from H, OH, a monovalent hydrocarbon group, a monovalent siloxane group and a mixture thereof; and R^{a} has Formula (IV):
—R³—X (IV)
wherein —R³ is selected from an alkylene group, an oxyalkylene group, an alkylene aryl group, an alkenylene group, an oxyalkenylene group, and an alkenylene aryl group; and X represents a group which includes at least one reactive functional group selected from a hydroxyl group, a carboxyl group, an isocyanate group, a blocked polyisocyanate group, a primary amine group, a secondary amine group, an amide group, a carbamate group, a urea group, a urethane group, a vinyl group, an unsaturated ester group, a maleimide group, a fumarate group, an anhydride group, a hydroxy alkylamide group, and an epoxy group.

Alternatively or in addition, the polysiloxane may be the reaction product of at least one of the following reactants:
(i) at least one polysiloxane of Formula (V):
   R₃Si—O—(SiR₂O—)ₙ—SiR₃ (V)
   wherein each R, which may be identical or different, represents a group selected from H, OH, a monovalent hydrocarbon group, a siloxane group and a mixture thereof, and at least one of the groups represented by R is H, and n′ ranges from 0 to 100, wherein the percentage of Si—H content in the polysiloxane ranges from 2 to 50; and
(ii) at least one molecule which includes at least one primary hydroxyl group and at least one unsaturated bond which can participate in a hydrolyzation reaction.

The metal nano powders in the ink and the antiabrasion-promoting nano particles/flexibility-promoting polymers may be crosslinked. The crosslinking is executed during the sintering of the ink which may be performed after the ink-jet printing of the ink, for example, to form the conductive lines on a substrate.

The present invention provides an improved substrate for a display including a ground substrate having a plurality of ink-jet printed conductive lines with improved adhesion and/or improved abrasion resistance and flexibility, the substrate including a metal adhesion promoting layer which is disposed between the ground substrate and the conductive lines, and at least one of colloidal silica nano particles, fumed silica nano particles, sol-gel nano particles, carbon nano particles, a silicone polymer, a functionalized silicone polymer, which are attached to the ground substrate and the conductive lines.

The metal adhesion promoting layer may include crosslinked molecules of Formula (VI) or crosslinked molecules of Formula (VII):
YRₙ (VI)
wherein Y is a N-, S-, or P-atom, n=2 or 3, and each R is independently a H-atom or an alkyl group; and
ZR′ₘ (VII)
wherein Z is a N-, S-, or P-atom, m=2 or 3, and each R′ is independently a H-atom or a silane group of Formula (VIII):
SiR″₃ (VIII)
wherein each R″ which may be identical or different is an alkyl group.

The metal adhesion promoting layer may include crosslinked molecules of Formula (IX):
RSiX₄ (IX)
wherein R is a H-atom, an OH-group , a Cl-atom, and/or an alkoxy group, and each X is independently a H-atom, an OH-group, a Cl-atom, an alkoxy group, an alkyl group, and/or an organic group, wherein the organic group includes at least one metal binding group.

The organic group may include at least one of amine, diamine, triamine, tetraamine, polyamine, amide, polyamid, hydrazine, pyridine, imidazole, thiophene, carboxylic acid, carboxylic acid halogenide, sulfide, disulfide, trisulfide, tetrasulfide, polysulfide, sulfonic acid, sulfonic acid halogenide, phosphate, phosphonate, epoxide, phenol, and polyether.

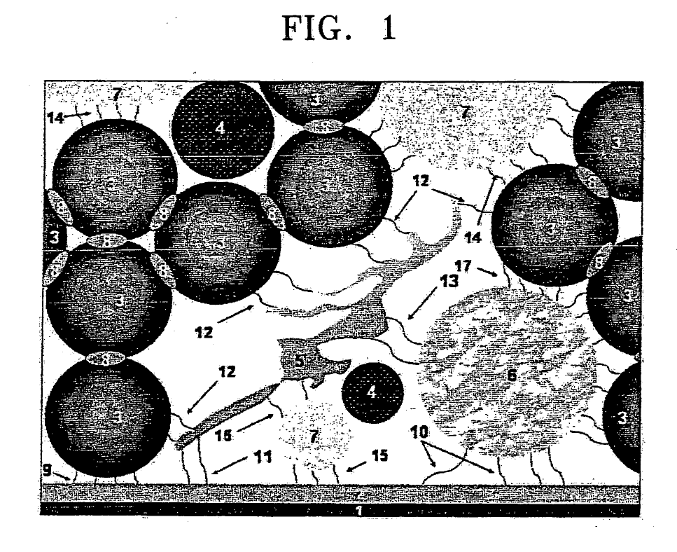

FIG. 1 is a sectional view of a substrate according to an embodiment of the present invention. Crosslinked antiabrasion-promoting nano particles 4, 6, 7 and a flexible polymer 5 (epoxy-functionalized polysiloxane) are crosslinked to silver nano particles 3 (preferably, 1-50 nm diameter) and a ground substrate 1 via an adhesion promoting layer 2 (plasma polymerized hexamethylsilazane). Sol-gel silica particles 6, silica particles 7 (for example, AEROSIL R-900 available from Degussa AG), and dispersed carbon particles 4 (for example, PRINTEX L6 available from CABOT Corp.) are bound to the silver particles 3 in order to improve the abrasion resistance of conductive lines formed using metal nano ink. Furthermore, the flexibility of the sintered metal nano ink is improved due to the flexible silicone polymer 5.

Conductive lines formed of sintered ink (ink sintered from the above-described substances) on the ground substrate 1 (indium tin oxide (ITO) coated glass substrate) and the metal adhesion promoting layer 2 (plasma polymerized hexamethylsilazane) improve the abrasion resistance and flexibility of the conductive lines.

The silver particles 3 are bound to each other via linkages 8. The flexible silicone polymer 5 is bound via linkages 11 to the metal adhesion promoting layer 2. The flexible silicone polymer 5 is bound via linkages 12 to the silver particles 3. The flexible silicone polymer 5 is bound via linkages 13 to the sol-gel particle 6. The silica particles 7 are bound via linkages 14 to the silver particles 3. The silica particles 7 are bound via linkages 15 to the metal adhesion promoting layer 2. The flexible silicones polymer 5 is bound via linkages 16 to the silica particles 7. The silver particles 3 are bound via linkages 17 to the sol gel particles 6.

A process of preparing a metal ink composition including abrasion resistance, adhesion and flexibility-promoting nano-scaled additives will be described.

The metal ink may be prepared by mixing at least one, preferably both, of antiabrasion-promoting nano particles and a flexibility-promoting polymer with common metal ink. At least one of colloidal silica nano particles, fumed silica nano particles, sol-gel nano particles, and carbon nano particles may be used as the anti-abrasion-promoting nano particles. A silicone polymer and/or a functionalized silicone polymer may be used as the flexibility-promoting polymer.

The mixing process may be performed by sonication. A surface modification of silica particles may be performed by condensation reactions with silanes having at least one metal adhesion functional group, wherein the metal adhesion functional group has at least one N-, O-, S-, and/or P-atom. The metal adhesion functional group may be selected from amine, diamine, triamine, tetraamine, polyamine, pyridine, imidazole, carboxylic acid, sulfonic acid, phosphate, phosphonate, and phenol.

The sol-gel nano particles may be synthesized through the co-condensation reaction of organo(alkoxy)-silanes with at least one organic functional group, wherein at least N-, O-, S-, and/or P-atom is present, or transition metal alkoxides or their copolymerization reactions with each other or with organic molecules are present.

A method of manufacturing a substrate for a display including a plurality of ink-jet printed conductive lines will be described.

The method includes: forming a metal adhesion layer on a ground substrate; and applying a metal ink to the metal adhesion layer by ink-jet printing to form a plurality of conductive lines. The metal ink preferably comprises at least one of colloidal silica nano particles, fumed silica nano particles, sol-gel nano particles, carbon nano particles, a silicone polymer, and a functionalized silicone polymer.

The metal adhesion promoting layer may be formed by a plasma treatment using NH₃, H₃S, and/or PH₃, a plasma treatment using a substance of Formula (VI), or a plasma polymerization with a silane of Formula (VII). Preferably, the substance of Formula (IX) is used in the forming the metal adhesion promoting layer. Preferably, the metal adhesion promoting layer is formed by a wet chemical process. In this case, the metal adhesion promoting layer is formed by dipping the ground substrate into the solution of the substance of Formula (VI).

Hereinafter, an embodiment of the present invention will be described in more detail with reference to the following examples. However, these examples are given for the purpose of illustration and are not intended to limit the scope of the invention.

### EXAMPLE

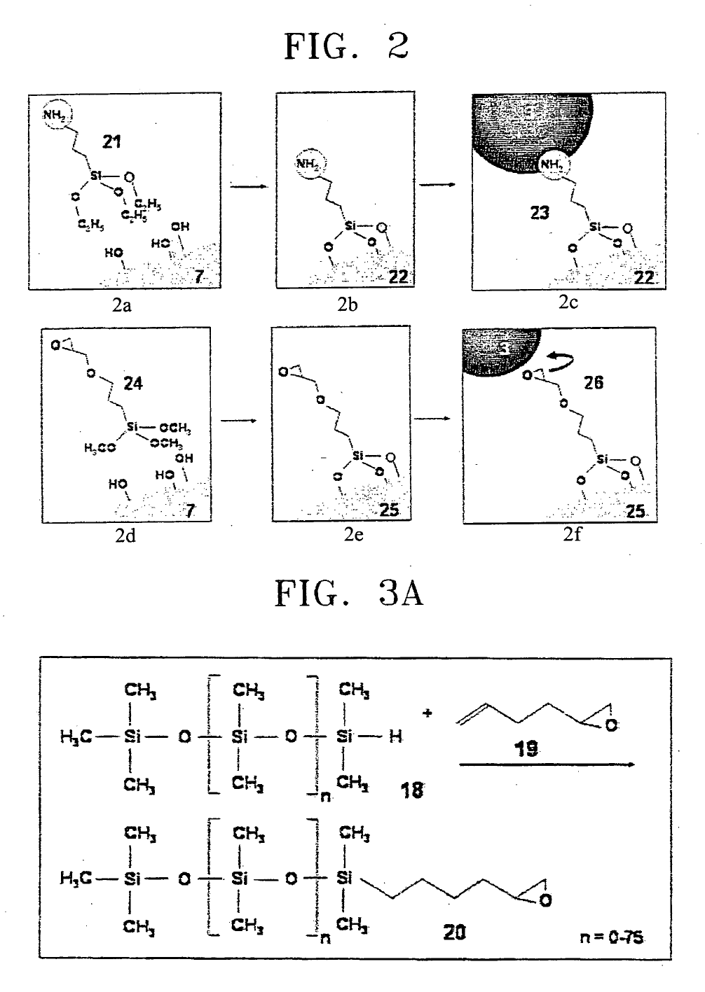

In a first operation, amino-functionalized silica particles 22 are prepared as shown in 2a and 2b of FIG. 2. 10 g of silica particles 7 (for example, AEROSIL R-900 available from Degussa AG) are dispersed in 300 ml of a 10⁻¹-10⁻³ mol/l ethanol solution of (3-aminopropyl) triethoxysilane 21 (functioning as a metal adhesion promoting silane). The mixture is stirred for 1 to 20 hours at 40 to 50° C. and dried at 40 to 100° C. The yielded amino-functionalized silica particles 22 are stored at room temperature.

In a second operation, epoxy-functionalized silica particles 25 are prepared as shown in 2d and 2e of FIG. 2. 10 g of the silica particles 7 (for example, AEROSIL R-900 available from Degussa AG) are dispersed in 300 ml of a 10⁻¹ to 10⁻³ mol/l ethanol solution of (3-glycidoxypropyl) trimethoxysilane (functioning as a metal adhesion promoting silane) 24. The mixture is stirred for 1 to 20 hours at 40 to 50° C. and dried at 40 to 70° C. The yielded epoxy-functionalized silica particles 25 are stored at room temperature.

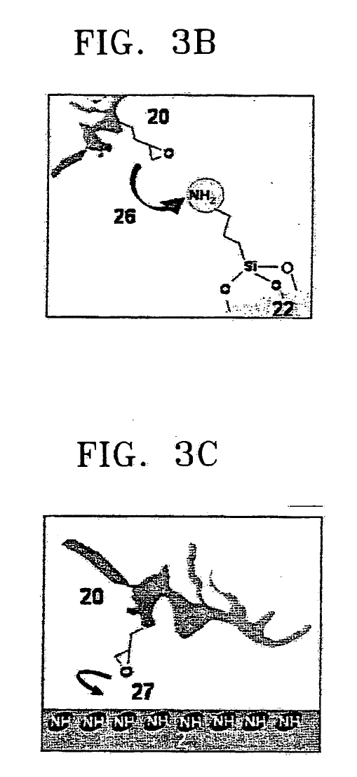

In a third operation, epoxy-functionalized polysiloxane 20 is prepared as shown in FIG. 3A. 10 g of 1.2-epoxy-5-hexene 19 and an amount of sodium bicarbonate equivalent to 20 to 25 ppm of the total monomer solid are put into a reaction vessel under nitrogen atmosphere, and the temperature is gradually increased up to 75° C. At this temperature, 5% of a total amount of 7.1 g polysiloxane containing silicone hydride 18 (for example, MASILWAX BASE from BASF Corp.) is added under agitation, followed by the addition of 0.02 g toluene, 0.005 g isopropanol and an equivalent to 10 ppm of chloroplatinic acid based on total monomer solid. Then, an exothermal reaction is allowed to 95° C. At the temperature, the remainder of the polysiloxane (containing silicone hydride) is added in an amount that does not rise temperature above 95° C. After completion of this addition, the reaction temperature is maintained at 95° C. and monitored by infrared spectroscopy until the silicone hydride absorption band (Si—H, 215 cm⁻¹) disappear.

In a fourth operation, the prepared amino-functionalized silica particles 22 (see 2b of FIG. 2), the epoxy-functionalized silica particles 25 (see 2e of FIG. 2) and the epoxy-functionalized polysiloxane 20 (see FIG. 3A) as well as milled carbon nano particles 4 (for example, PRINTEX L6 available from CABOT Corp.) and silver ink (for example, silver nano particles 3 dissolved in a solvent) are mixed by sonication. The weight percentages of these additives range from 0.1 to 20 based on the total weight of the metal ink. The epoxy-functionalized polysiloxane 20 can be bounded to the amino-functionalized silica particles 22, as shown in FIG. 3B. The silver particles 3 can be bounded to the amino-functionalized silica particles 22 via a linkage 23, as shown in 2c of FIG. 2. Alternatively or in addition, the silver particles 3 can be bonded to the epoxy-functionalized silica particles 25 via a linkage 26, as shown in 2f of FIG. 2.

The obtained silver nano ink composition can be ink-jet printed on the ground substrate 1 having an adhesion promoter layer 2 (plasma polymerized hexamethylsilazane) using a multi-nozzle ink-jet printer. The binding 27 of the epoxy-functionalized polysiloxane 20 to the adhesion promoter layer 2 is shown in FIG. 3C. To form solid ink-jet printed conductive lines the printed ground substrate is heated at 100 to 250° C. for 20 to 70 minutes. The obtained substrate can be used in a process involved in the manufacturing of a plasma display panel (PDP).

As a result of ink-jet printing using the silver nano ink composition, the abrasive resistance, adhesion, and flexibility of the cured silver lines are improved, which is important requirement in manufacturing a PDP, specifically when forming ink-jet printed address and bus electrodes on a flexible substrate.

In principle, the presence of cross-linked ink additives based on Si—O—C, C—N—C, C—N, C—O, C—S and C—P linkages can be detected by Electron Spectroscopy for Chemical Analysis (ESCA) and Attenuated Total Reflectance Fourier Transform Infrared Spectroscopy (ATR-FTIR). The average particle size can be determined by examining electron micrographs obtained by transmission electron microscopy (TEM), measuring the diameter of the particles in TEM images, and calculating the average particle size based on the TEM images.

According to the present invention as described above, the adhesion of conductive lines such as ink-jet printed address and bus electrodes to a ground substrate for a PDP, the abrasive resistance and flexibility thereof are improved, and then the life-time and the flexibility of the ground substrate are improved.

While the present invention has been particularly described with reference to exemplary embodiments thereof, it is evident that many alternatives, modifications and variations will be apparent to those of ordinary skilled in the art. Accordingly, the preferred embodiments of the invention as set forth herein are intended to be illustrative, not limiting. Various changed may be made without departing from the spirit of the invention as defined by the following claims.

What is claimed is:

1. A metal ink, comprising:
dispersed metal powders in a solvent; and
at least one additive of antiabrasion-promoting nano particles and a flexibility-promoting polymer.

2. The metal ink of claim 1, wherein the metal powders are metal nano powders, and said at least one additive comprises the antiabrasion-promoting nano particles including at least one of colloidal silica nano particles, fumed silica nano particles, sol-gel nano particles, and carbon nano particles.

3. The metal ink of claim 1, wherein the metal powders are metal nano powders, and said at least one additive comprises the flexibility-promoting polymer including at least one of a silicone polymer and a functionalized silicone polymer.

4. The metal ink of claim 3, wherein the silicone polymer comprises at least one polysiloxane of Formula (I):
R¹ₙR²ₘSiO_{(4-n-m)/2} (I)
wherein each R¹ independently represents H, OH, a monovalent hydrocarbon group, or a monovalent siloxane group;
each R² independently represents a group having at least one reactive functional group; and
0<n<4, 0<m<4 and 2≦(m+n)<4.

5. The metal ink of claim 4, wherein the reactive functional group is a hydroxyl group, a carboxyl group, an isocyanate group, a blocked polyisocyanate group, a primary amine group, a secondary amine group, an amide group, a carbamate group, a urea group, a urethane group, a vinyl group, an unsaturated ester group, a maleimide group, a fumarate group, an anhydride group, a hydroxy alkylamide group, or an epoxy group.

6. The metal ink of claim 3, wherein the silicone polymer comprises at least one polysiloxane of Formula (II) or (III):
R₃Si—O—(SiR₂O—)ₙ—(SiRR^{a}O)ₘ—SiR₃ (II)
R^{a}R₂Si—O—(SiR₂O—)ₙ—(SiRR^{a}O)ₘ—SiR₂R^{a} (III)
wherein m has a value of at least 1;
m′ ranges from 0 to 75;
n ranges from 0 to 75;
n′ ranges from 0 to 75;
each R is independently H, OH, a monovalent hydrocarbon group, a monovalent siloxane group or a mixture thereof; and
R^{a} has Formula (IV):
—R³—X (IV)
wherein —R³ is selected from the group consisting of an alkylene group, an oxyalkylene group, an alkylene aryl group, an alkenylene group, an oxyalkenylene group, and an alkenylene aryl group; and
X represents a group having at least one reactive functional group selected from the group consisting of a hydroxyl group, a carboxyl group, an isocyanate group, a blocked polyisocyanate group, a primary amine group, a secondary amine group, an amide group, a carbamate group, a urea group, a urethane group, a vinyl group, an unsaturated ester group, a maleimide group, a fumarate group, an anhydride group, a hydroxy alkylamide group, and an epoxy group.

7. The metal ink of claim 3, wherein the silicone polymer comprises at least one polysiloxane which is a reaction product of at least one the following reactants:
(i) at least one polysiloxane of Formula (V):
R₃Si—O—(SiR₂O—)ₙ—SiR₃ (V)
wherein each R is independently H, OH, a monovalent hydrocarbon group, a siloxane group, or a mixture thereof; and at least one R is H, and n′ ranges from 0 to 100, and the percent of Si—H content of the at least one polysiloxane ranges from 2 to 50 percent; and
(ii) at least one molecule having at least one primary hydroxyl group and at least one unsaturated bond capable of participating in a hydrolyzation reaction.

8. The metal ink of claim 1, wherein the metal powders are metal nano powders, and the metal nano powders and said at least one additive are crosslinked.

9. A method of preparing a metal ink, the method comprising:
mixing at least one additive of antiabrasion-promoting nano particles and a flexibility-promoting polymer with metal powders in a solvent.

10. The method of claim 9, wherein said at least one additive comprises the antiabrasion-promoting nano particles including at least one of colloidal silica nano particles, fumed silica nano particles, sol-gel nano particles, and carbon nano particles.

11. The method of claim 9, wherein said at least one additive comprises the flexibility-promoting polymer including at least one of a silicone polymer and a functionalized silicone polymer.

12. The method of claim 9, wherein the mixing is performed by sonication.

13. The method of claim 10, wherein the antiabrasion-promoting nano particles are prepared by surface-modifying silica nano particles through a condensation reaction with silane having at least one metal adhesion functional group having at least one of a N atom, an O atom, a S atom, and a P atom.

14. The method of claim 13, wherein the metal adhesion functional group is amine, diamine, triamine, tetraamine, polyamine, pyridine, imidazole, carboxylic acid, sulfonic acid, phosphate, phosphonate, or phenol.

15. The method of claim 10, wherein the sol-gel nano particles are synthesized from co-condensation reactions of organo(alkoxy)-silanes with at least one organic functional group, wherein at least of a N, O, S, and P-atom is present, or transition metal alkoxides or copolymerization reactions of transition metal alkoxides with each other or with organic molecules are present.

16. A substrate for a display, comprising:
a group substrate;
a plurality of conductive lines;
a metal adhesion promoting layer disposed between the ground substrate and the conductive lines; and
at least one additive of antiabrasion-promoting nano particles and a flexibility-promoting polymer which are attached to the metal adhesion promoting layer and to the conductive lines.

17. The substrate of claim 16, wherein said at least one additive comprises the antiabrasion-promoting nanoparticles including at least one of colloidal silica nano particles, fumed silica nano particles, sol-gel nano particles, and carbon nano particles.

18. The substrate of claim 16, wherein said at least one additive comprises the flexibility-promoting polymer including at least one of silicone polymers and functionalized silicone polymers.

19. The substrate of claim 16, wherein the metal adhesion promoting layer comprises at least one of a crosslinked molecule of Formula (VI), a crosslinked molecule of Formula (VII) and a crosslinked molecule of Formula (IX):
YRₙ (VI)
wherein Y is a N-, S-, or P-atom, each R is independently a H-atom or an alkyl group, and n=2 or 3; and
ZR′ₘ (VII)
wherein m=2 or 3, Z is a N-, S-, or P-atom, and each R′ is independently a H-atom or a silane group with Formula (VIII):
SiR″₃ (VIII)
wherein each R″ is independently an alkyl group; or
RSiX₄ (IX)
wherein R of Formula (IX) is a H-atom, an OH-group , a Cl-atom, or an alkoxy group, and each X is independently a H-atom, an OH-group, a Cl-atom, an alkoxy group, an alkyl group, or an organic group having at least one metal binding group.

20. The substrate of claim 19, wherein the organic group comprises at least one of amine, diamine, triamine, tetraamine, polyamine, amide, polyamid, hydrazine, pyridine, imidazole, thiophene, carboxylic acid, carboxylic acid halogenide, sulfide, disulfide, trisulfide, tetrasulfide, polysulfide, sulfonic acid, sulfonic acid halogenide, phosphate, phosphonate, epoxide, phenol, and polyether.

21. A flat panel display panel having the substrate of claim 16.

22. A method of manufacturing a substrate for a display, the method comprising:
forming a metal adhesion layer on a ground substrate; and
applying a metal ink to the metal adhesion layer by ink-jet printing to form a plurality of conductive lines, the metal ink comprising metal powders dispersed in a solvent, and at least one additive of antiabrasion-promoting nano particles and a flexibility-promoting polymer.

23. The method of claim 22, wherein said at least one additive comprises the antiabrasion-promoting nanoparticles including at least one of colloidal silica nano particles, fumed silica nano particles, sol-gel nano particles, and carbon nano particles.

24. The method of claim 22, wherein said at least one additive comprises the flexibility-promoting nano particles including at least one of a silicone polymer, and a functionalized silicone polymer.

25. The method of claim 22, wherein the metal adhesion promoting layer is formed by a plasma treatment using NH₃, H₃S, and/or PH₃, a plasma treatment using a substance of Formula (VI), or a plasma polymerization with a silane of Formula (VII):
YRₙ (VI)
wherein Y is a N-, S-, or P-atom, each R is independently a H-atom or an alkyl group, and n=2 or 3; and
ZR′ₘ (VII)
wherein m=2 or 3, Z is a N-, S-, or P-atom, and each R′ is independently a H-atom or a silane group with Formula (VIII):
SiR″₃ (VIII)
wherein each R″ is independently an alkyl group.

26. The method of claim 22, wherein a substance of Formula (IX) is used in the forming of the metal adhesion promoting layer:
RSiX₄ (IX)
wherein R is a H-atom, an OH-group , a Cl-atom, or an alkoxy group, and each X is independently a H-atom, an OH-group, a Cl-atom, an alkoxy group, an alkyl group, or an organic group having at least one metal binding group.

27. The method of claim 22, wherein the metal adhesion promoting layer is formed by a wet chemical process.

28. The method of claim 27, wherein the metal adhesion promoting layer is formed by dipping the ground substrate into the solution of a substance of Formula (VI):
YRₙ (VI)
wherein Y is a N-, S-, or P-atom, n=2 or 3, and each R is independently a H-atom or an alkyl group.
